(19) United States
(12) Patent Application Publication
(10) Pub. No.: US 2003/0080995 A1
(43) Pub. Date: May 1, 2003

(54) Contextually adaptive web browser

(75) Inventors: Samuel Sergio Tenenbaum, Punta Del Este (UY); Manuel Caballero, Buenos Aires (AR)

Correspondence Address: DARBY & DARBY P.C., P. O. BOX 5257, NEW YORK, NY, 10150-5257, US

(73) Assignee: UNITED VIRTUALITIES, INC., New York, NY

(21) Appl. No.: 10/116,763

(22) Filed: Apr. 3, 2002

Related U.S. Application Data
(60) Provisional application No. 60/329,243, filed on Oct. 12, 2001.

(51) Int. Cl. G09G 5/00

(52) U.S. Cl. 345/738

(57) ABSTRACT

A web browser's layout, available features and tools are adapted to the instantaneous environment, without the use of downloadable, up-loadable or resident programs, plug-ins or agents. The browser itself is tailored to the context in which it is being used, to provide for different functionalities in the browser tool bar, the functionality changing in association with different data such as a web page requested, web page content, the user demographic classification, age, location, or any other characteristic known or inferred by such provider. This mutation occurs according to factors preset by the user (surfer) or pushed by the provider or a third party authorized by a service or content provider.

This patent application claims the priority of U.S. Provisional Patent Application Serial No. 60/329,243 filed Oct. 12, 2001.

### FIELD OF THE INVENTION

The present invention relates to a method for adaptively customizing the functions and capabilities of a web browser, a system to achieve the method, and the resulting browser. It can be used to tailor the buttons, features and tools that are available to a user while viewing a web page depending on the nature of the content viewed as well as parameters set by the user or a sponsoring website. It can also be used to increase the commercially available space in a given web page, as well as the exposure time commercialized by a web site.

### BACKGROUND OF THE INVENTION

Most users connect to the Internet through a personal computer running an operating system with a graphic user interface (GUI), such as one of the Windows& operating systems. A user communicates over the Internet using a program called a “browser”, the two most popular ones being Internet Explorer and Netscape, although many other browsers are in common use. The browser receives files in a format known as HTML, which is a mark-up language that permits multimedia to be embedded within formatted and stylized text. Various programming languages, such as Javascript, are also available which permit executable code to be embedded in an HTML file and to run when a browser presents the file to the user.

Users of the Internet are therefore quite familiar with the browser as a vehicle for surfing the Internet. Until the present invention the browser remained fixed and did not change in its functionality and/or its display in relation to its context. Functions and tools could be customized by changing browser preferences or by downloading plug-ins and helper applications, but they did not dynamically adapt to the site being currently viewed and/or other parameters such as user behavior and preferences.

In order to enhance and optimize the Internet surfing experience it would be desirable to adapt the browser's layout, available features and tools to the instantaneous environment, without the use of downloadable, up-loadable or resident programs, plug-ins or agents. In other words, it would be desirable to tailor the browser itself to the context in which it is being used, to provide for different functionalities in the browser tool bar, the functionality changing or mutating in association with different data such as a web page requested, web page content, the user demographic classification, age, location, or any other characteristic known or inferred by such provider. This mutation would occur according to factors preset by the user (surfer) or pushed by the provider or a third party authorized by a service or content provider.

The described functionality could be provided by a Browser Provider, which may or may not be authorized by the user to manage his browsing experience by customizing the browser and/or including advertisements on the viewed pages and/or the tool bar.

An ancillary use for the present invention is to deliver customized advertisements to the user along with the aforementioned functionality. In addition to customizing the browser, many types of advertisements can be served in the process. From buttons and banners to rich media, Shoshkeles™ and sponsored tools. Additionally, this allows for the commercial exploitation of screen real estate previously preserved from this use, such as the tool bar, and for commercialization and sponsoring by parties other than the content provider, such as the Browser Provider.

For example, the user may choose to have a print button everywhere he surfs or just in news-sites. Or he may want to have pornographic material filtered, to have virus scanning of the content or the data received, to be invisible partially or totally to a web site or a third party related to that website, to prevent cookies from playing on his machine, or to receive a contextual browser change and/or any filtering the provider of the browser may choose to offer.

As another example, the provider may choose a contextual graphic and/or material display of the browser that changes partially or totally in relation to the website or content requested or viewed, such as having a homework button on the browser when the site visited is a children's site. In this case, the homework button may include tools to help children do homework, such as a calculator, a dictionary or a note taker. It could also include a search box or a link to a website or page in which the user or his/her parents could buy books or any other products.

Another use would be the inclusion of contextual advertisement inserted, not by the content provider, as is currently common, but by the Browser Provider. For example, when the user arrives at a specific website or page that has a certain add for a company such as a flower merchant, the Browser Provider may choose to show a related add from the same merchant or a competing one seemingly on top of that add or somewhere else on the screen, including the browser button area; or to show an animated character with or without sound, such as a Shoshkele™. As another example, when the user chooses to review or request a product or a service to be bought or leased, such as an airplane ticket, the provider may choose to offer on top of the screen, or on any part of the screen, a similar airline ticket on another carrier that is either better or cheaper.

### BRIEF DESCRIPTION OF THE DRAWING

The foregoing brief description, as well as further objects, features and advantages of the present invention, will be understood more completely from the following detailed description of presently preferred, but nonetheless illustrative, embodiments with reference being had to the accompanying drawings, in which:

FIG. 1 is a flowchart illustrating the operation of the preferred method for producing a contextually adaptive web browser and the operation of a system which does so, both in accordance with the present invention;

FIG. 2 is a functional block diagram illustrating an alternate method embodying the invention and the operation of a system which provide a contextually adaptive browser; and

FIGS. 3-7 are exemplary screen shots demonstrating the use and operation of a contextually adaptive browser in accordance with the present invention.

### DETAILED DESCRIPTION OF THE PREFERRED EMBODIMENTS

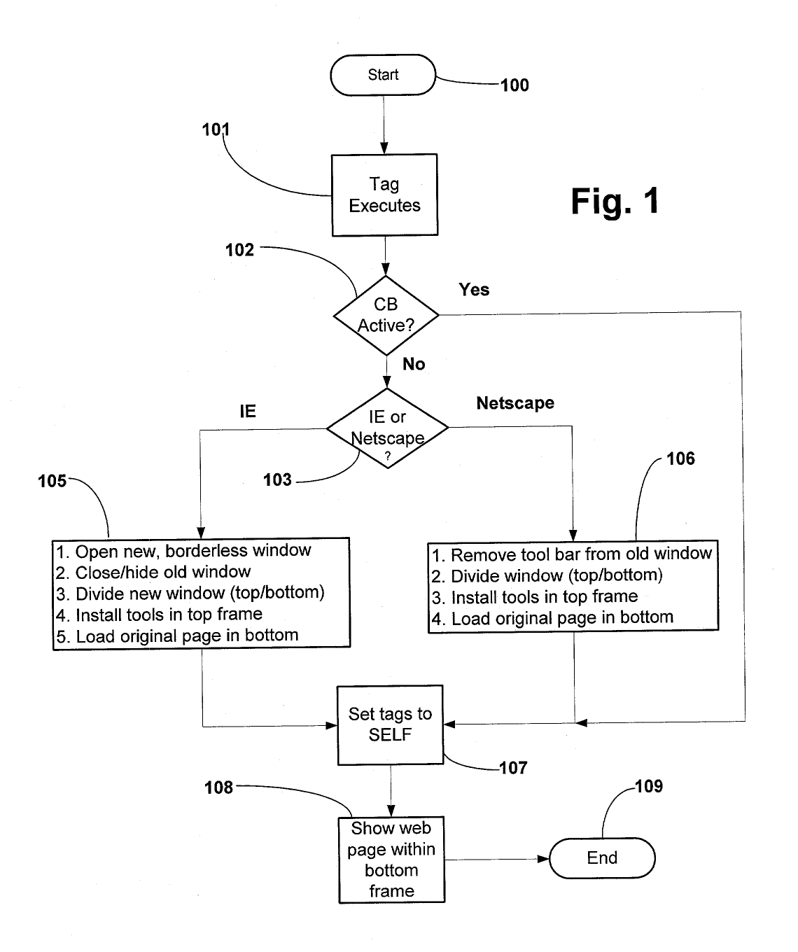

The contextually adaptive browser, hereafter also referred to as a contextual browser or “morphing browser”, works by delivering functionality along with the content when an HTML page is requested by the user. The preferred embodiment of the invention involves two functional phases (described in FIG. 1): activation of the contextual browser; and operation of the contextual browser.

Activation of the contextual browser involves removing the standard browser page tool bar and replacing it with a customized one. This operation is done in different ways depending on the browser engine being used. With Internet Explorer, the preferred method includes:

closing or hiding the current browser window;

opening a new window without a border or toolbar;

splitting the new window into upper and lower frames; and

placing the new contextual tools in the top frame while reserving the lower frame to display web pages.

If the browser is Netscape, it is possible to remove the standard toolbar without closing the current window and opening a new one. After removing the toolbar, the steps which follow are similar to those performed with Internet Explorer: splitting the window into upper and lower frames and placing the new contextual tools in the top frame, while displaying web pages in the lower one.

Contextual browser (CB) activation is initiated when the user logs on to a web page having an embedded tag (a request within the page for code from a remote source). As can be seen in the flowchart of FIG. 1, execution of the tag (block 101) causes a test to be performed regarding whether the CB is already active (Block 102). If it is, operation skips to block 107; otherwise, operation continues at block 103 where a determination is made of the kind of browser being used. If the browser is Internet Explorer (IE), operation continues at block 105; and if the browser is Netscape, operation continues at block 106.

At block 105 (browser is IE) several actions take place: a new, border-less window is opened, the original window is closed or hidden (depending on the version of the browser), the new window is divided into upper and lower frames, the contextual navigation tools are loaded onto the top frame and the web page which contained the CB tag is loaded onto the bottom frame.

At block 106 (browser is Netscape) the tool bar is removed from the current window, the window is split into upper and lower frames; the contextual navigation tools are loaded into the upper frame, and the web page which contained the CB tag is loaded into the bottom frame.

Distinct methods are used for the two browsers, owing to the diverse capabilities of the browsers. Regardless of the browser, operation resumes at block 107, where those tags which include the TARGET parameter (a designation of where called code is to be executed), are set to a value equal to SELF (a designation to execute the code at the location of the tag. This is done to prevent a value of TOP (a designation to execute on the top level of the page) from breaking the frames. At block 108 the web page is rendered inside the lower frame, and the process ends at block 109.

In order to endow the CB with its basic functionality it becomes necessary to replace the navigation toolbar, which is removed as described above, with a customized or contextual tool bar. This new tool bar must include the essential navigational commands, allowing users to browse the web, but it can also contain custom tools, like games, chat, IM, virus scan, etc. Table 1 is a list of basic browser functions, including Operating System GUI elements, that must be replaced in order to provide users with the standard browser features they have come to expect. It should be noted that, by the very nature of the invention, these components can be tailored, reshuffled, sponsored, augmented, etc . . .

It should also be noted that some of these functions are GUI essentials, which are stripped out by utilizing a border-less window and must be replaced for the standard window operation; like the ability to drag or minimize a window

TABLE 1

a) Drag Window
b) Minimize Window
c) Maximize Window
d) Restore Window
e) Refresh/Reload Page
f) Back Page
g) Forward Page
h) Stop Loading of Page
i) Print Page
j) Mail Page
k) URL address box

Documented code related to this embodiment of the invention appears in Appendix A.

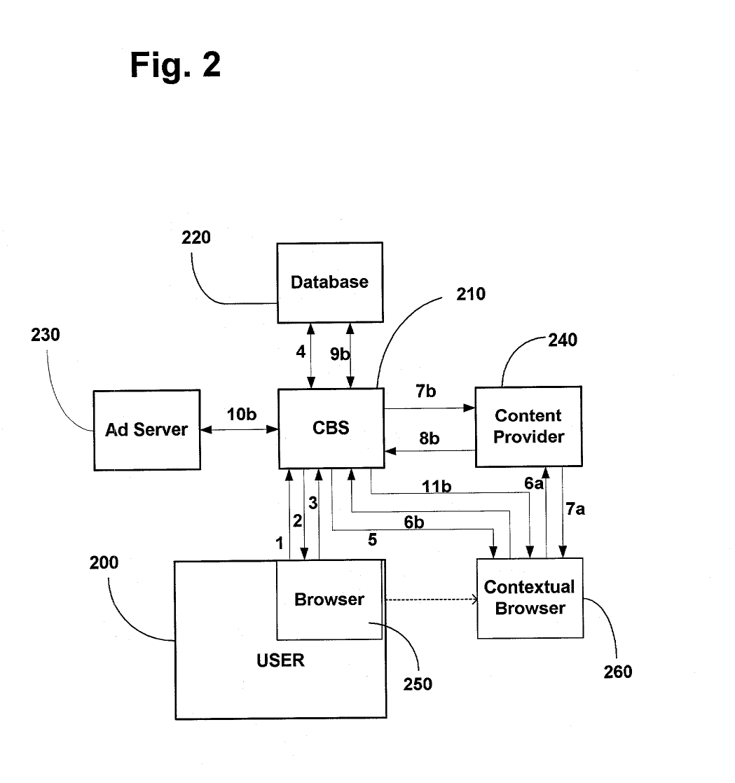

Referring to the functional block diagram of FIG. 2 which relates to an alternate embodiment, of a contextually adaptive browser, it will be seen that functionality is accomplished by having the user 200 communicate with the contextual browser provider at a Contextual Browser Server (CBS) 210, using his regular browser 250. The user initiates the process by logging on to the contextual browser provider home page CBS 210 (communication 1 in FIG. 2). The CBS delivers its home page HTML code to the user (communication 2) including a link, displayed on the page, to activate the contextual browser. When the user clicks on the contextual browser link, browser 250 opens a new HTML document window 260, in full screen mode, on the user's computer. The HTML document for window 260, which will become the contextual browser, includes HTML code requesting the user's personalized browsing tools and a personal home page from the CBS (communication 3).

Making use of parameters it receives from user 200, CBS 210 retrieves user preferences from Database 220 (communication 4) and assembles a new HTML document which includes a personalized set of tools for the current context, along with the user's personal home page inside a frame. This HTML document is then delivered to the user (communication 5) and his computer receives and executes it, activating the contextual browser.

Hereafter, whenever the user requests a web page operation may occur in one of two modes. In the first mode, the contextual browser operates with the new toolbar and capabilities, but remains unchanged. In this mode the request goes directly to the content provider 240 (communication 6a), resulting in the update of only the frame containing the home page, while the rest of the HTML document is preserved. In this scenario, all pages requested from this point on would be received from the content provider 240 and displayed within the frame contained in the HTML document generated by the CBS.

In the second mode of operation, the contextual browser 260 continues to be adaptive. Content requests from user 200 are redirected through CBS 210 (communication (6b). The CBS then requests the content from the content provider 240 (communication 7b) and analyzes available data such as user preferences, content being viewed and user behavior to determine what tools and what layout better suits the current activity. CBS 210 then assembles into a new HTML document the required set of tools, based on information received from database 220 (communication 9b) and optional data received from Ad Server 230 (communication 10b), along with the requested content, and this new document is delivered to the user 100 (communication 11b). This allows for further customization of the tool set, permitting the CBS to dynamically change the set of features provided to the user depending on the page being viewed. In this case, not only is the content of the user's frame changed when displaying a new page, but the entire HTML document is changed.

Through a series of screen shots, some of the capabilities of the present invention will now be demonstrated.

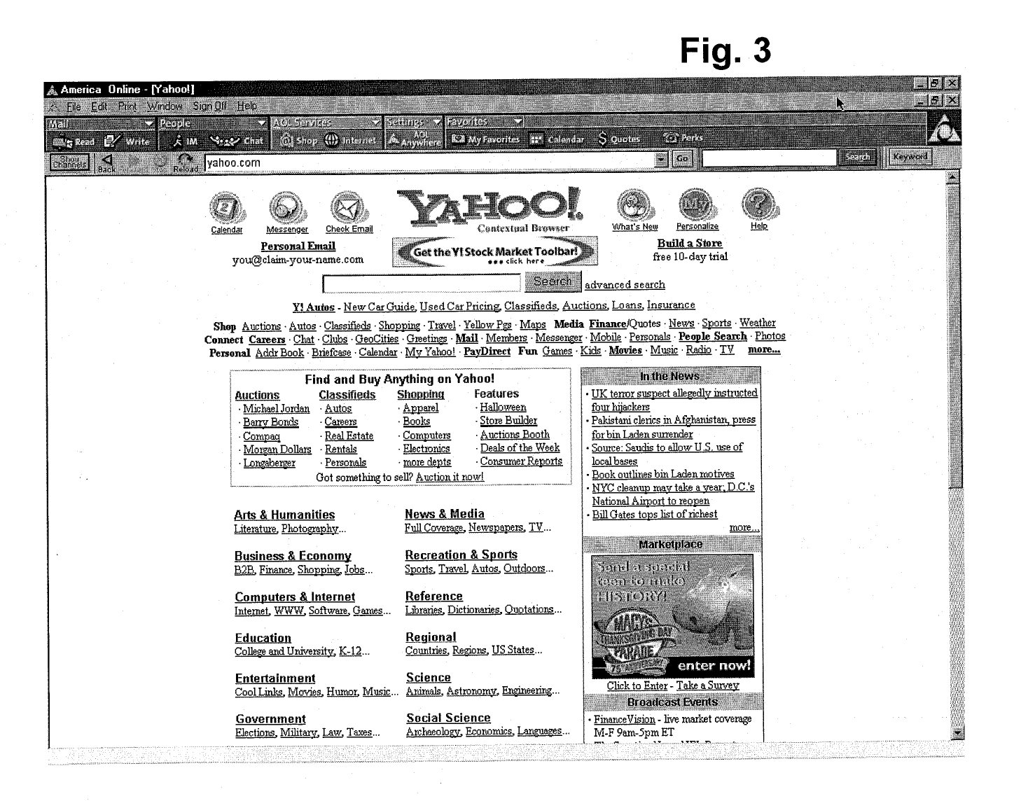

FIG. 3 is a screen shot of a browser window customized for America Online presenting a page from Yahoo.com. Here some of the conventional tool bar elements are present, but the toolbar is highly customized.

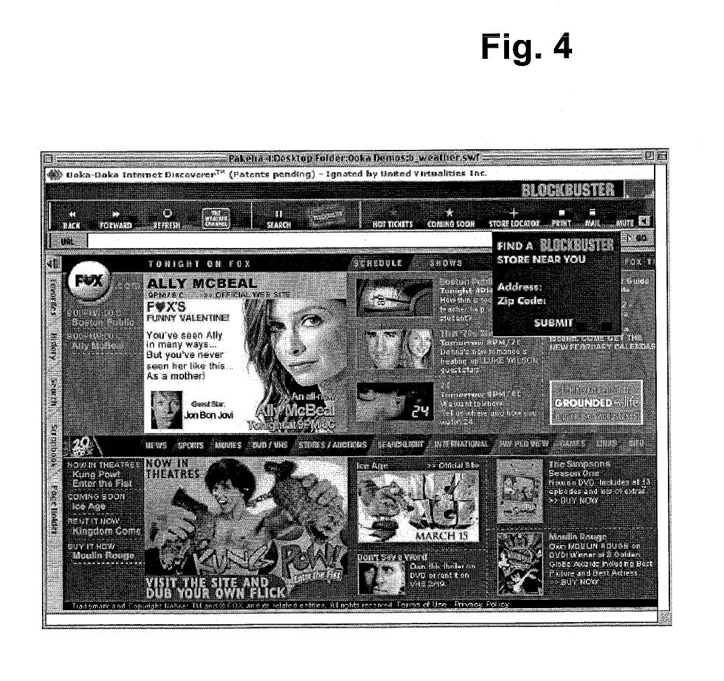

FIG. 4 illustrates a browser window customized for Blockbuster Video showing a page from Fox.com. The toolbar is entirely customized, and a drop down menu has been activated to locate the nearest Blockbuster store.

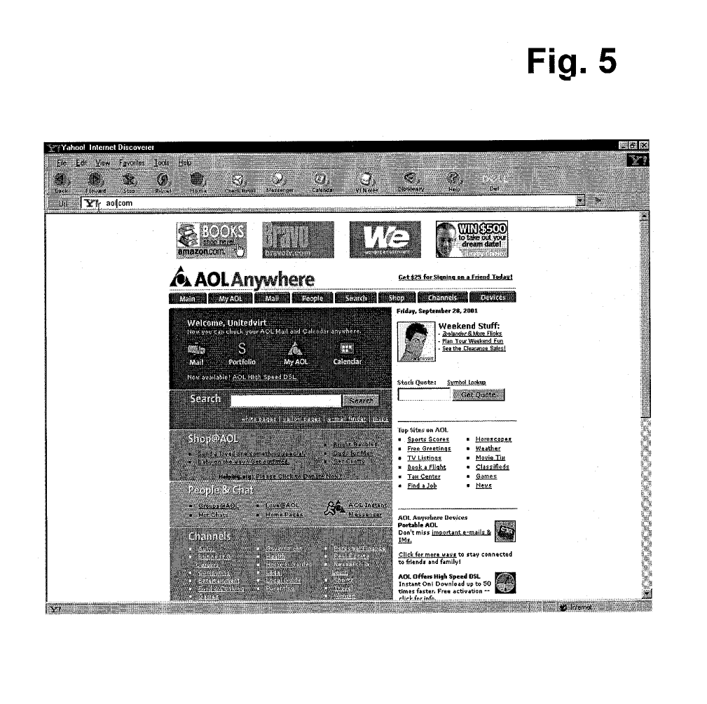

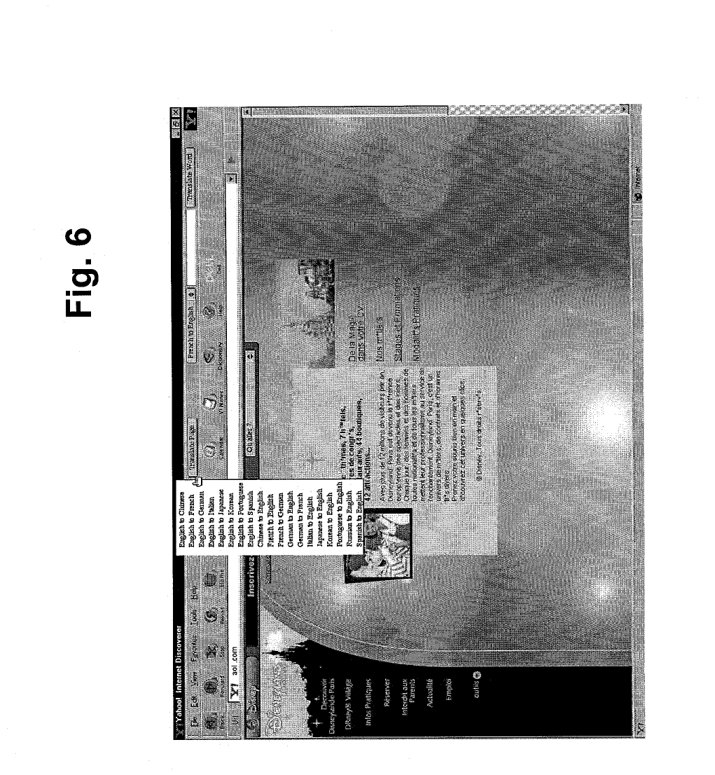

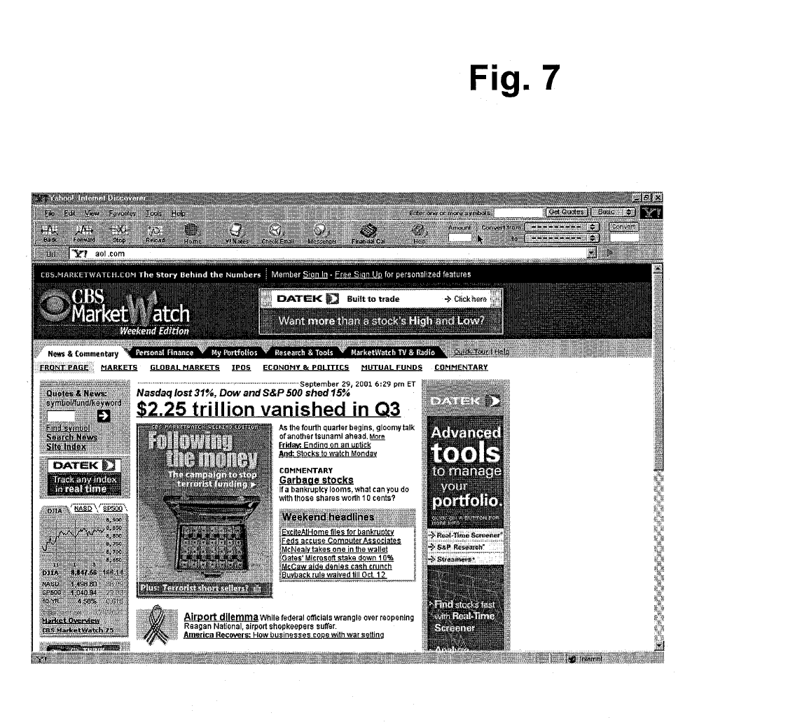

FIGS. 5-7 illustrate a contextually adaptive browser window that has been customized for Yahoo.com. The toolbar provides branding exposure for Yahoo. In each case, however, the user is using the Yahoo browser to view his Internet service provider's site (America On Line). In FIG. 6, the user has accessed a foreign language page, which was sensed by the browser, and a translation drop down menu was provided. In FIG. 7, the user has entered a financial site, and the browser has adapted its context by using financial symbols in the toolbar and providing an icon which permits access to a financial calculator.

Although a preferred form of the invention has been disclosed for illustrative purposes, those skilled in the art will appreciate that many additions, modifications and substitutions are possible without departing from the scope and spirit of the invention as defined by the accompanying claims. For example, those skilled in the art will appreciate that the invention is not limited to existing browser programs operating with HTML code. It will work equally well with any browser-like program designed to exhibit multimedia pages.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for changing the layout, available features and functionality, or tools of a page appearing on a web browser running in a window on a user's computer, the method including the step of transferring to the browser from a remote location executable code, the code comprising:
a first code portion converting the window to a modified window having no tool bar;
a second code portion dividing the modified window into plural frames;
a third code portion installing a set of substitute tools in a first of the frames; and
a fourth code portion recreating the original page in second frame; web pages being thereafter viewed in the second frame, while substitute tools may be operated in the first frame.

2. The method of claim 1, wherein the first code portion comprises a subportion which opens a new, border-less window; and a subportion which closes or hides the original window.

3. The method of claim 1, wherein the executable code is structured to arrange the first and second frames one above the other in a display of the user's computer.

4. The method of claim 1, wherein the executable code further comprises a fifth code portion monitoring the user's activity on the browser and transferring information related thereto to the remote location, the remote location transferring additional executable code to the user's computer effective to further change the layout, available features and functionality or tools appearing on the modified page.

5. The method of claim 4, further comprising sending advertising information to user's computer for display in at least one of the frames.

6. The method of claim 5, wherein the remote location has a database containing information about the user and the content of at least one of the frames controlled in relationship to the information in the database.

7. The method of claim 1, further comprising sending advertising information to user's computer for display in at least one of the frames.

8. The method of claim 7, wherein the remote location has a database containing information about the user and the content of at least one of the frames is controlled in relationship to the information in the database.

9. The method of claim 1, wherein the remote location has a database containing information about the user and the content of at least one of the frames is controlled in relationship to the information in the database.

10. The method of claim 7 wherein at least a portion of information contained in one of the frames is left unchanged.

11. The method of claim 5 wherein at least a portion of information contained in one of the frames is left unchanged.

12. The method of claim 4 wherein at least a portion of information contained in one of the frames is left unchanged.

13. The method of claim 1 wherein at least a portion of information contained in one of the frames is left unchanged.

14. The method of claim 1, wherein the executable code further comprises a fifth code portion which causes any TARGET parameters present in any frame to be set to a value equal to SELF.

15. The method of claim 4, wherein the additional executable code includes a code portion which causes any TARGET parameters present in any frame to be set to a value equal to SELF.

16. A method for changing the layout, available features and functionality, or tools of a window containing an original page appearing on a web browser running in a window on a user's computer, comprising the steps of:
transferring to the browser from a remote location a first signal which opens on the user's computer a modified window in full screen mode, the signal including executable code sending a notification to the remote location that the window was opened;
maintaining at the remote location a database containing information about the user, including a definition of the user's custom home page;
responsive to the notification and making use of information in the database, transferring to the browser from the remote location a second signal which causes the new window to be customized for the user, creating a customized home page.

17. The method of claim 1, wherein the modified window is created by opening a new, border-less window; and closing or hiding the original window.

18. The method of claim 16, further comprising, when the user requests a web page from a content provider, forwarding the request to the content provider, receiving a page of information from the content provider, and displaying it in the window with the context of the modified window.

19. The method of claim 16, further comprising, when the user requests a web page from a content provider:
forwarding the request to the remote location;
at the remote location:
forwarding the request to the content provider;
receiving a page of information from the content provider;
composing a further signal defining a window to be displayed by the user's computer; and
sending the further signal to the user's computer.

20. The method of claim 19, further comprising, at the user's computer, receiving the further signal; restructuring the new window to have a context determined by the further signal; and displaying in the restructured window the page of information from the content provider.
